(19) United States
(12) Patent Application Publication
(10) Pub. No.: US 2004/0075859 A1
(43) Pub. Date: Apr. 22, 2004

(54) Printer instruction processing

(76) Inventors: Dana A. Jacobsen, Boise, ID (US); Nolan W. Letellier, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/274,256

(22) Filed: Oct. 17, 2002

(51) Int. Cl. G06F 3/12; G06F 13/00; G06F 11/30

(52) U.S. Cl. 358/1.15; 358/1.13; 710/19

(57) ABSTRACT

Systems, methods and apparatus for processing printer instructions are provided. One method includes resolving a processing status of a target printer and evaluating a printer instruction format.

### FIELD

The present invention relates to printer technologies, and in particular to printer instruction processing.

### BACKGROUND

A printing job involves a printer driver creating an instruction set which is sent to a printing engine for rendering an image. A printer driver can be in desktop, laptop, workstation, or other host computer and the printing engine can be located in a peripheral printer. A Page Description Language (PDL) is a device independent, high level language for instructing the printing engine of a printer to print text and graphics on a page. Two major languages currently in use are Adobe's Postscript and Hewlett-Packard's PCL (print control language).

With a PDL, much of the character and graphics shaping is done within the printer, by the printing engine, rather than in a user's computer. Instead of downloading an entire font from a computer to a printer, which includes the design of each character, a command to build a particular font is typically sent, and the printer creates the characters from font outlines. Likewise, a command to draw a circle is sent to the printer rather than sending the actual bits of the circle image. Laser printers typically operate using a PDL. Unfortunately, the execution of PDL instructions can quickly tax a printing engine causing print jobs to back up.

External RIP (Raster Image Processor) devices are sometimes used to enhance printer performance. These can be host-based or an external device. Dedicated RIPs are designed to generate output image data based on a compact input representation such as a PDL instruction set. A traditional dedicated RIP will output a video-ready-data (VRD) instruction set. The VRD format includes an instruction set which has been PDL parsed, rendered, color converted, half-toned, and compressed in a format a printer can take as an image directly to a sheet of paper. Typically a dedicated RIP will accelerate all print jobs to the VRD format.

One aspect with sending VRD is that it creates high network traffic. Another problem is that VRD is printer dependent. Another aspect is that often the target for the output from the dedicated RIP is a fully functional printer. In this system environment, the printing engine in the printer, or printer RIP, is left unused, or under utilized, which is a waste of resources.

### BRIEF DESCRIPTION OF THE DRAWINGS

FIG. 1A illustrates a system according to an embodiment of the invention.

FIG. 1B illustrates another system according to an embodiment of the invention.

FIG. 2 is a flow chart illustrating a method according to an embodiment of the invention.

FIG. 3 is a flow chart illustrating a method according to an embodiment of the invention.

FIG. 4 is a flow chart illustrating a method according to an embodiment of the invention.

FIG. 5 is a flow chart illustrating a method according to an embodiment of the invention.

FIG. 6 is a flow chart illustrating a method according to an embodiment of the invention.

FIG. 7 is a diagram illustrating a computer readable medium and associated instruction set according to an embodiment of the invention.

### DETAILED DESCRIPTION

The following description and drawings are provided to illustrate specific embodiments of the invention to enable those skilled in the art to practice it. Other embodiments may incorporate structural, logical, electrical, process, and other changes. Examples merely demonstrate some possible variations. Individual components and functions are optional unless explicitly required, and the sequence of operations may vary. Portions and features of some embodiments may be included in or substituted for those of others. The scope of the invention encompasses the full ambit of the claims and all available equivalents. The following description is, therefore, not to be taken in a limited sense.

The functions described herein are implemented in software in one embodiment, where the software comprises computer executable instructions stored on computer readable media such as memory or other types of storage devices. The term “computer readable media” is also used to represent carrier waves on which the software is transmitted. Further, such functions correspond to modules, which are software, hardware, firmware or any combination thereof. Multiple functions are performed in one or more modules as desired, and the embodiments described are merely examples.

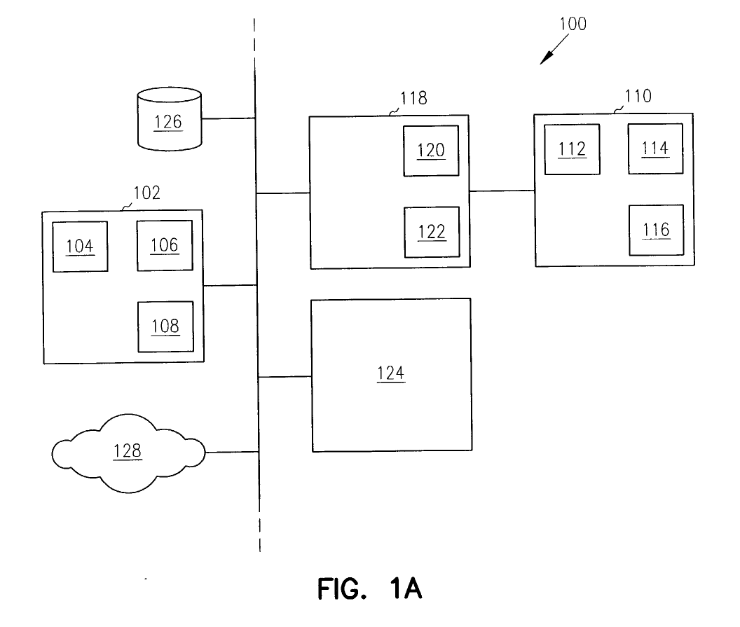

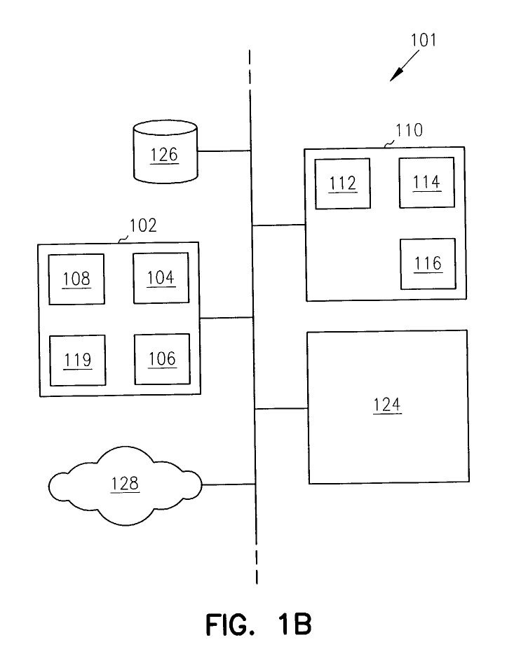

FIG. 1A illustrates a system 100 according to an embodiment of the invention. As shown in FIG. 1A, the system 100 includes a remote terminal 102. In various embodiments, the remote terminal 102 can include a desktop computer, a laptop computer, a workstation, or other host computer as the same will be known and understood by one of ordinary skill in the art. The remote terminal 102 can include one or more processors 104 and one or more memory devices 106 suitable for running software and/or application modules thereon. In the embodiment shown in FIG. 1A, the remote terminal includes a printer driver 108. As one of ordinary skill in the art will understand upon reading this description, a printer driver 108 is operable to create an instruction set for a print job which can be sent to a printing engine for rendering an image. Printer driver 108 includes any printer driver suitable for carrying out the aspects of the present invention. That is, the printer driver 108 can take output from applications running on remote terminal 102 and transform them into a print job.

In various embodiments of the present invention, the printer driver outputs an instruction set in a Page Description Language. For purposes of this invention, a PDL is a device independent, high level language for instructing the printing engine of a printer to print text and graphics on a page. Two major languages are Adobe's Postscript and Hewlett-Packard's PCL (print control language).

As shown in FIG. 1A, remote terminal 102 is connected to a printer 110 via system 100. Printer 110 includes a printing engine 112, or printer raster image processor 112. Printer 110 can include one or more processors 114 and one or more memory devices 116 suitable for running software and/or application modules thereon. As one of ordinary skill in the art will understand upon reading this description, the software and/or application modules include any software and/or application modules suitable for carrying out the aspects of the present invention.

As one of ordinary skill in the art will appreciate, system 100 includes a network having data links. Further as one of ordinary skill in the art will appreciate network can include any number of network types including, but not limited to a Local Area Network (LAN), a Wide Area Network (WAN), and the like. Likewise, data links can include any combination of direct wired and wireless connections, including but not limited to electrical, optical and RF connections.

In the embodiment of FIG. 1A, remote terminal 102 is connected to printer via an external RIP 118. That is, a RIP which is external to the printer 110. RIP 118 includes one or more processors 120 and one or more memory devices 122 suitable for running software and/or application modules thereon.

As one of ordinary skill in the art will understand upon reading this description, the software and/or application modules include any software and/or application modules suitable for carrying out the aspects of the present invention. Such software and/or application modules can be resident in one location or in several and even many locations, such as in a distributed computing environment, throughout a system.

Further, as shown in the embodiment of FIG. 1A, system 100 can include other peripheral devices 124, storage devices 126, and Internet connections 128 as the same can be included within a network.

FIG. 1B illustrates another system 101 according to the teachings of the present invention. The system 101 shown in FIG. 1B is similar to the system 100 shown in FIG. 1A and is operable to perform various aspects according to the teachings of the present invention. However, in the embodiment of FIG. 1B, a host-based RIP 119 is provided. In one embodiment, as shown in FIG. 1B, host-based RIP 119 is included within remote terminal 102. As one of ordinary skill in the art will appreciate upon reading this disclosure, host-based RIP 119 is similar to the external RIP 118 shown in FIG. 1A in that it is operable to perform various aspects of the present invention.

As stated above, printer driver 108 includes any printer driver 108 which is suitable for carrying out the aspects of the present invention. That is, printer driver can take output from applications running on remote terminal 102 and transform them into a print job.

In various embodiments of the present invention, the printer driver outputs an instruction set in Page Description Language. For the purposes of this invention, a PDL is a device independent, high level language for instructing the printing engine of a printer to print text and graphics on a page. Two major languages are Adobe's Postscript and Hewlett-Packard's PCL.

According to the various aspects of the present invention, the printer driver 108 outputs the PDL to either an external RIP 118 (as shown in FIG. 1A) or to a host-based RIP 119 (shown in FIG. 1A). As stated above, RIPs are designed to generate output image data based on a compact input representation such as a PDL instruction set. Each page contained in a PDL instruction set can be parsed and operated upon by software to further process, resolve, and/or interpret the instruction set commands of a print job.

A traditional dedicated RIP will output a video-ready-data (VRD) instruction set. The VRD format includes an instruction set which has been PDL parsed, rendered, color converted, half-toned, and compressed in a format a printer can take as an image directly to a sheet of paper. Essentially, in the VRD format, no additional instruction set processing is performed by the printing engine to transfer the image to the sheet of paper. Typically a dedicated RIP will accelerate all print jobs to the VRD format. VRD is typically printer dependent. Therefore, it is not always desirable for an RIP to process the PDL to the VRD format. Likewise, the VRD format creates high network traffic on a system, such as system 100 of FIG. 1A or system 101 of FIG. 1B. According to aspects of the present invention, consideration must be taken as to the size of the file sent in most systems.

As one of ordinary skill in the art will understand, a range of instruction set formats of varying size and complexity exists between the device-independent, high-level PDL and the VRD format. By way of example and not by way of limitation, a next stage, next instruction set layer, or next instruction set format, which includes a measure of processing beyond that of the PDL, is a simplified PDL. In some embodiments, processing a PDL to a simplified PDL includes operating on, parsing, or going through the PDL instructions and taking out, or performing, some of the operations, e.g. creating a color version. Simplified PDL can be a simple modification or a complex transformation, such as transforming a Postscript smooth shading command into a simple raster. In this manner, it can be possible to convert a PDL description from a complex page to a simple page. A next stage, next instruction set layer, or next instruction set format, which includes a measure of processing beyond that of the simplified PDL, is a complex display list. In some embodiments, processing a simplified PDL to a complex display list includes parsing the PDL to create a set of ordered graphical objects, including converting PDL functions to graphical objects. A next stage, next instruction set layer, or next instruction set format, which includes a measure of processing beyond that of the complex display list, is a display list. In some embodiments, processing a complex display list to a display list includes fully scaling the raster to account for the device resolution, e.g. 600 dpi, and rotating raster to account for device orientation, e.g. landscape or portrait. A next stage, next instruction set layer, or next instruction set format, which includes a measure of processing beyond that of the display list, is a device independent PDL single image. In some embodiments, processing a display list to a PDL single image includes rendering the image and incorporating it in a PDL instruction set such as Postscipt or PCL. This format is device independent. A next stage, next instruction set layer, or next instruction set format, which includes a measure of processing beyond that of the PDL single image, is the VRD format.

According to aspects of the invention, as one of ordinary skill in the art will understand upon reading this disclosure, the decision to process an instruction set between one instruction format and a next stage, next instruction set layer, or next instruction set format includes a consideration of the file size of an instruction set format and the processing work which must be performed to achieve the same. According to aspects of the invention, processing an instruction set format to provide a different instruction set format does not necessarily have to be performed in the sequence described above nor use of the exact stages listed. The invention is not so limited and can include other instruction set formats known to those of ordinary skill in the art.

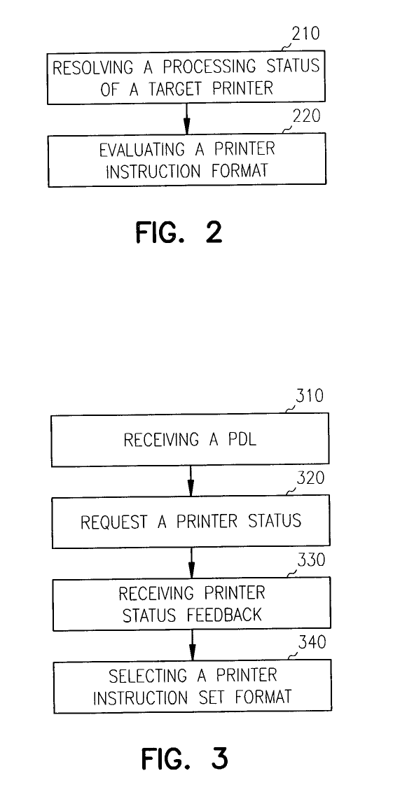

FIGS. 2-6 are flow charts illustrating various method aspects of the invention. As one of ordinary skill in the art will understand, the methods can be performed by software, application modules, and computer executable instructions, operable systems such as shown in FIGS. 1A and 1B, to achieve the same. The invention, however, is not limited to any particular operating environment or software written in a particular programming language.

FIG. 2 is a flow chart illustrating a method according to an embodiment of the invention. As shown in the embodiment of FIG. 2, the method includes resolving a processing status of a target printer, such as target printer 100 in FIG. 1A, at block 210. In one embodiment, resolving the processing status of the target printer at block 210 includes modeling the processing status. In this embodiment an algorithm is created which includes evaluating an amount of time required to handle the print job and an amount of time available on the target printer. In one embodiment, the modeling algorithm includes evaluating whether a printer engine of the target printer will be fully utilized. In these embodiments, no communication is required from the printer to the external or host-based RIP, however, the given printer type and configuration of the target printer should be known. In these embodiments it is possible that the external or host-based RIP will process a current instruction set format to provide a different instruction set format, stage, or layer, as described above, even though the target printer is not busy.

In another embodiment, resolving a processing status of a target printer at block 210 includes querying, polling, or requesting a current print status from the target printer. Here too, an algorithm, performed by software, can be used to query, poll or request the current print status from the target printer. This embodiment, involves communication between the printer and the external or host-based RIP; however the given printer type and configuration does not necessarily need to be known. In other words, the external or host-based RIP asks the printer whether it is available or busy. The algorithm of this embodiment can be useful in a system with a print job having many pages, but in some instances can be less desirable if few pages are sent and the first one is very complex.

In addition, according to some embodiments of the present invention, the above described methods for resolving a processing status of a target printer are combined.

As shown in the embodiment of FIG. 2, the method includes evaluating a printer instruction format at block 220. In one embodiment, evaluating a printer instruction format at block 220 includes changing the printer instruction format. In one embodiment, evaluating the printer instruction format at block 220 includes selecting a printer instruction format, such as the printer instruction formats described above, based on the processing status. That is, selecting a printer instruction format includes selecting a printer instruction format from the group of: a simplified PDL, a complex display list, a display list, a PDL single image, and video-ready data. The invention, however, is not limited to just these formats.

Thus, by way of example and not by way of limitation, if the target printer is busy the external or host-based RIP processes the printer instruction format to provide a different format. And, in some embodiments, the method returns to block 210 to resolve the processing status once a page has been further processed to the different format. On the other hand, if the target printer is not busy, then the external or host-based printer sends the current printer instruction format to the target printer. In this manner, the printing engine, or printer RIP, is kept busy while the external or host-based RIP works ahead and each page of a print job is processed so that the remainder of the processing can be accomplished quickly by the printing engine, or printer RIP.

FIG. 3 is a flow chart illustrating a method according to an embodiment of the invention. In FIG. 3, a method of printer instruction processing is provided. The method includes receiving a PDL at block 310. At block 320, the method includes requesting a printer status. At block 330, the method includes receiving printer status feedback. And, at block 340, the method includes selecting a printer instruction format. In one embodiment, when the printer status feedback indicates the printer is busy, the method further includes processing the PDL to provide a more printer ready format. Alternatively, when the printer status feedback indicates the printer is available, the method includes sending the current printer instruction format to the printer. As described herein, processing the PDL to a more printer ready format includes processing the PDL to a next stage. As described herein, processing the PDL to a next stage includes a next stage selected from the group of a simplified PDL, a complex display list, a display list, a PDL single image, and video-ready data. The invention, however, is not limited to just these formats. According to aspects of the present invention, requesting, receiving, and processing are repeated until the printer status feedback indicates the printer is available.

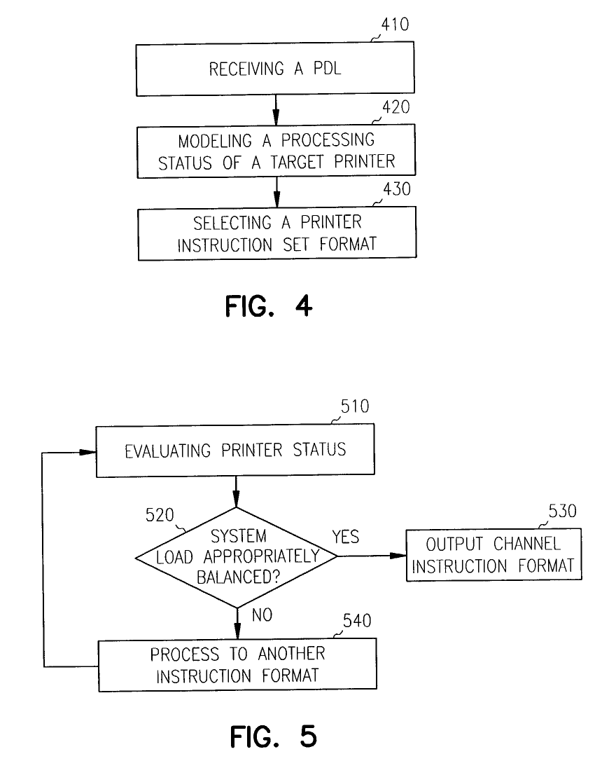

FIG. 4 is a flow chart illustrating a method according to an embodiment of the invention. In FIG. 4, a method of printer instruction processing is provided. The method includes receiving a PDL at block 410. At block 420, the method includes modeling a processing status of a target printer. As described above, in one embodiment, modeling a processing status of the target printer at block 420 includes modeling how fast a print job can be handled for a given printer type and configuration. At block 430, the method includes selecting a printer instruction format. In one embodiment, based on the modeling result, the method includes deciding whether to send the PDL to the printer or to process the PDL to a different instruction set layer, as the same have been described above. As described above, in one embodiment an algorithm is created which includes evaluating the amount of time required to handle the print job and the amount of time available on the target printer. In one embodiment, the modeling algorithm includes evaluating whether a printer engine of the target printer will be fully utilized.

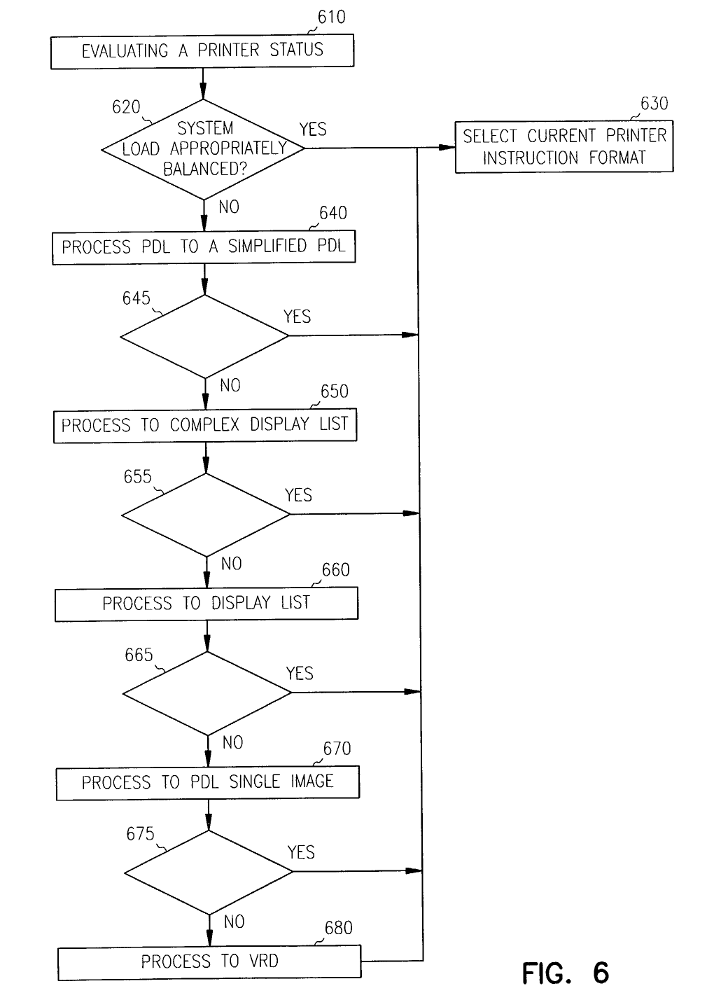

FIG. 5 is a flow chart illustrating a method according to an embodiment of the invention. Again, as with all the methods, FIG. 5 includes methods performed by instructions executable by a suitably programmed information handling system. In some embodiments of the present invention, the set of instructions include receiving a PDL for a print job, evaluating a status of a target printer, and balancing the processing load of the print job between a host-based RIP (or an RIP external to the target printer) and a printing engine of the target printer. According some aspects of the present invention, balancing a load for processing the print job between a host-based RIP or an RIP external to the target printer and a printing engine of the target printer includes means for distributing a print job processing load between a host-based RIP or an RIP external to the target printer and a printing engine of the target printer. And, in some embodiments, means for distributing a print job processing load between a host-based RIP or an RIP external to the target printer and a printing engine of the target printer includes equalizing the processing load between the host-based RIP or the RIP external to the target printer and the printing engine in order to maximize a throughput of the print job and in order to maximize a utilization of the printing engine.

As shown in the embodiment of FIG. 5, the method includes evaluating a printer status at block 510. In block 520, the method includes determining whether a system load between the host-based RIP or the RIP external to the target printer and the printing engine of the target printer is appropriately balanced. If the answer is yes, then the host-based RIP or an RIP external to the target printer outputs the current instruction format to the printer at 530. If the answer is no, then the method proceeds to block 540 where the current instruction format is processed to another instruction format, as the same has been described herein. The method then returns to block 510 and once again evaluates the printer status.

FIG. 6 is a flow chart illustrating a method according to an embodiment of the invention. As shown in the embodiment of FIG. 6, the method includes evaluating a printer status at block 610 according to the teachings described herein. In block 620, the method determines whether a system load between the host-based RIP or the RIP external to the target printer and the printing engine of the target printer is appropriately balanced. In one embodiment, “appropriately balanced” is intended to mean that a threshold requirement, which can be a predetermined threshold requirement, has been satisfied such that a throughput of a print job and a utilization of a printing engine have been maximized. In this manner, the resources of a system, such as a host computer connected via a network to a printer, are taken into account.

If the answer at block 620 is yes, then the host-based RIP or a RIP external to the target printer selects the current printer instruction format at 630. If the answer is no, then the method proceeds to block 640 and processes a PDL to a simplified PDL. The method then proceeds to block 645, at which point the evaluation process analogous to that performed in block 620 is repeated. Once again, if the answer is yes, then the host-based RIP or an RIP external to the target printer selects the current printer instruction format at 630. If the answer is no, then the method proceeds to block 650 and processes a simplified PDL to a complex display list. The method then proceeds to block 655, at which point an evaluation process analogous to that performed in block 620 is repeated. Once again, if the answer is yes, then the host-based RIP or an RIP external to the target printer selects the current printer instruction format at 630. If the answer is no, then the method proceeds to block 660 and processes a complex display list to a display list. The method then proceeds to block 665, at which point an evaluation process analogous to that performed in block 620 is repeated. Once again, if the answer is yes, then the host-based RIP or a RIP external to the target printer selects the current printer instruction format at 630. If the answer is no, then the method proceeds to block 670 and processes a display list to a PDL single image. The method then proceeds to block 675, at which point an evaluation process analogous to that performed in block 620 is repeated. Once again, if the answer is yes, then the host-based RIP or an RIP external to the target printer selects the current printer instruction format at 630. If the answer is no, then the method proceeds to block 680 and processes a PDL single image to a VRD.

According to the various embodiments of the present invention, the methods of FIG. 6 can be performed in an order other than the sequence listed. That is, in some embodiments various formats are processed and/or selected in an order different from the order shown in FIG. 6. For example, by way of illustration, and not by way of limitation, in block 620 the method determines whether a system load between the host-based RIP or the RIP external to the target printer and the printing engine of the target printer are appropriately balanced and if the answer is no, then the method proceeds to process a PDL to a complex display list before another evaluation is performed. The list of formats included in FIG. 6 is not exhaustive and other formats are considered within the scope of various embodiments of the invention. Within each listed stage there are several variations which would still fall under the same general heading listed above. Those skilled in the art will understand that the exact variations need not be exactly defined but that each stage is more printer ready that the previous.

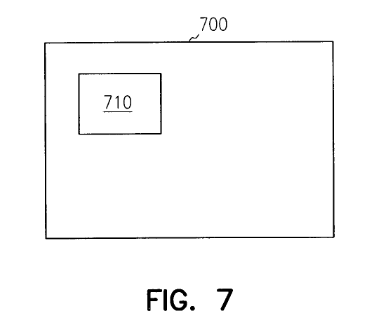

FIG. 7 is a schematic diagram illustrating a computer-readable medium 700 and an associated instruction set 710, according to an embodiment of this invention. The computer-readable medium 700 can be any number of computer-readable media including a floppy drive, a hard disk drive, a network interface, magnetic medium, an rf signal, a carrier wave, an interface to the internet, or the like. The computer-readable medium 700 can also be a hard-wired link included in a network or an infrared or rf carrier. The instruction set 710 can be any set of instructions that are executable by an information handling system associated with the printer instruction processing discussed. For example, the instruction set can include an instruction set for performing the methods discussed with respect to FIGS. 2-6. Other instruction sets can also be associated with the computer-readable medium 700.

Although specific embodiments have been illustrated and described herein, those of ordinary skill in the art will appreciate that any arrangement calculated to achieve the same purpose can be substituted for the specific embodiments shown. This disclosure is intended to cover any and all adaptations or variations of various embodiments of the invention. It is to be understood that the above description has been made in an illustrative fashion, and not a restrictive one. Combinations of the above embodiments, and other embodiments not specifically described herein will be apparent to those of skill in the art upon reviewing the above description. The scope of various embodiments of the invention includes any other applications in which the above structures and methods are used. Therefore, the scope of various embodiments of the invention should be determined with reference to the appended claims, along with the full range of equivalents to which such claims are entitled.

It is emphasized that the Abstract is provided to comply with 37 C.F.R. §1.72(b) requiring an Abstract that will allow the reader to quickly ascertain the nature of the technical disclosure. It is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment.

1. A method of printer instruction processing, comprising:
receiving a page description language (PDL) instruction set for a print job;
polling a status of a printer;
receiving a feedback status responsive to polling the status of the printer; and
when the feedback status indicates the printer is busy, processing the PDL instruction set to provide a more printer ready format.

2. The method of claim 1, wherein, when the feedback status indicates the printer is available, the method further includes sending the PDL to the printer.

3. The method of claim 1, wherein processing the PDL includes processing the PDL using a raster image processor (RIP) selected from a host-based RIP or an external RIP.

4. The method of claim 1, wherein processing the PDL to provide a more printer ready format includes processing the PDL to a next stage.

5. The method of claim 4, wherein the polling, receiving, and processing are repeated after each next stage until the feedback status indicates the printer is available or all processing has been done.

6. The method of claim 4, wherein processing the PDL to the next stage includes selecting the next stage from one or more of a simplified PDL, a complex display list, a display list, a PDL single image, and a video ready data.

7. A method of printer instruction processing, comprising:
receiving a page description language (PDL) instruction set for a print job associated with a given printer type and configuration;
modeling a workload for the given printer type and configuration; and
based on the modeling, deciding whether to send the PDL instruction set or to process the PDL instruction set to a different instruction set layer.

8. The method of claim 7, wherein deciding whether to send the PDL instruction set or to process the PDL instruction set to a different instruction set layer, based on the modeling, includes evaluating an amount of time required to handle the print job and an amount of time available on a target printer.

9. The method of claim 7, wherein deciding whether to send the PDL instruction set or to process the PDL instruction set to a different instruction set layer, based on the modeling, includes evaluating whether a printer engine of a target printer will be fully utilized.

10. The method of claim 7, further including processing the PDL instruction set to a different instruction set layer using a raster image processor (RIP) selected from a host-based RIP or an external RIP.

11. The method of claim 7, further including processing the PDL instruction set to a different instruction set layer selected from one or more of a simplified PDL, a complex display list, a display list, a PDL single image, and a video ready data.

12. A set of instructions executable by a suitably programmed information handling system, comprising:
creating a PDL for a print job;
evaluating a status of a target printer; and
balancing a load for processing the print job between an RIP external to the target printer and a printing engine of the target printer.

13. The set of instructions of claim 12, wherein evaluating the status of the target printer includes modeling how fast the print job can be handled for a given type and configuration of the target printer.

14. The set of instructions of claim 13, wherein balancing the load for processing the print job includes processing the PDL to a different format even if a current print status of the target printer is a not busy status.

15. The set of instructions of claim 12, wherein balancing the load for processing the print job includes a combination of modeling how fast the print job can be handled for a given type and configuration of the target printer and polling a current print status of the target printer.

16. The set of instructions of claim 12, wherein evaluating the status of the target printer further includes:
requesting a current print status of the target printer;
receiving the current print status; and
wherein balancing a load includes processing the PDL to a different format, when the current print status is a busy status.

17. The set of instructions of claim 16, wherein balancing the load for processing the print job includes sending the PDL to the target printer if a current print status of the target printer is a not busy status determined during a first request.

18. The set of instructions of claim 16, wherein processing the PDL to a different format includes processing the PDL using a raster image processor (RIP) selected from a host-based RIP and an external RIP.

19. The set of instructions of claim 16, wherein processing the PDL to a different format includes processing the PDL to a format selected from one or more of:
a. a simplified PDL format;
b. a complex display list format;
c. a display list format;
d. a PDL single image format; and
e. a video ready data format.

20. The set of instructions of claim 19, wherein the formats are selected in the order presented and wherein the requesting, receiving, and processing are repeated after each format is selected until the current print status indicates the target printer is available.

21. The set of instructions of claim 20, further including sending a current format to the target printer once the current print status indicates the target printer is available.

22. A system, comprising:
a host computer having a printer driver;
a printer having a printing engine;
means for receiving a print job; and
means for re-distributing a print job processing load between an RIP external to the printer and the printing engine.

23. The system of claim 22, wherein the means for re-distributing the print job processing load between the RIP external to the printer and the printing engine includes a set of computer executable instructions for changing an output format of the RIP external to the printer.

24. The system of claim 22, wherein the means for re-distributing the print job processing load between the RIP external to the printer and the printing engine includes equilibrating the processing load between the RIP external to the printer and the printing engine in order to maximize a throughput of the print job and a utilization of the printing engine.

25. A computer readable medium having instructions for causing a device to perform a method of processing printer instructions, comprising:
resolving a processing status of a target printer; and
evaluating a printer instruction format to be sent to the target printer.

26. The medium of claim 25, wherein resolving the processing status of the target printer includes modeling the processing status.

27. The medium of claim 25, wherein resolving the processing status includes querying the target printer.

28. The medium of claim 25, wherein evaluating the printer instruction format includes changing the printer instruction format.

29. The medium of claim 25, wherein the medium includes a carrier wave.

30. The medium of claim 25, wherein evaluating the printer instruction format includes selecting a printer instruction format based on the processing status.

31. The medium of claim 30, wherein the selecting a printer instruction format includes selecting a printer instruction format from the group including one or more of a simplified PDL, a complex display list, a display list, a PDL single image, and a video ready data.
